(19) United States
(12) Patent Application Publication
(10) Pub. No.: US 2023/0264864 A1
(43) Pub. Date: Aug. 24, 2023

(54) CAP MADE OF PAPER

(71) Applicants: TUNAP GMBH & CO. KG, Wolfratshausen (DE); STEINBEIS-HOCHSCHULE-BERLIN GMBH, Berlin (DE); OECOPAC GRUNERT VERPACKUNGEN GMBH, Coswig (DE); TECHNISCHE UNIVERSITÄT DRESDEN, Dresden (DE)

(72) Inventors: André HOFMANN, Mittweida (DE); Marek HAUPTMANN, Dippoldiswalde (DE); Jochen GRUNERT, Dresden (DE); Steffen HEROLD, Chemnitz (DE)

(21) Appl. No.: 18/006,369

(22) PCT Filed: May 27, 2021
(86) PCT No.: PCT/EP2021/064175

§ 371 Date: Jan. 20, 2023

(30) Foreign Application Priority Data
Jul. 23, 2020 (DE) 10 2020 119 510.9

(51) Int. Cl. B65D 41/18; B31B 50/81; B31F 1/00

(52) U.S. Cl. CPC B65D 41/18; B31B 50/81; B31F 1/0006; B31B 2120/40

(57) ABSTRACT

A cap and a corresponding method of manufacturing the cap for closing a container are described. The cap comprises a spirally wound sleeve comprising a first opening an a second opening, wherein the first opening and the second opening are opposed. Further, the cap comprises a head disk, wherein the head disk is arranged to close the first opening of the sleeve. The sleeve is made of paper. The second opening of the sleeve has a reinforcing element, and the reinforcing element is a structure extending into the interior of the sleeve.

This application is the national phase of International Application No. PCT/EP2021/064175 filed 27 May 2021 which designated the U.S. and claims priority to German Patent Application 10 2020 119 510.9 filed 23 Jul. 2020, the entire contents of each of which are hereby incorporated herein by reference.

### TECHNICAL FIELD

Embodiments of the present disclosure relate to a cap made of paper for closing a container, in particular an aerosol can. Further embodiments of the present disclosure relate to a method of manufacturing a cap for closing a container.

### BACKGROUND

Caps, in particular caps for aerosol cans, which are made of petrochemical plastics (in particular polypropylene or polyethylene) are known. Typically, such conventional caps for aerosol cans are produced in manufacturing processes, e.g. injection molding. In general, the reusability or recyclability of conventional caps is rather low and very energy- and cost-intensive, so that a large part of conventional caps are disposed of as residual waste in a landfill or as fuel in a waste incineration plant. as a result, the CO₂ balance and environmental compatibility of conventional aerosol can caps is poor. The CO₂ balance is the balance of greenhouse gas emissions along the entire life cycle of a product in a defined application and related to a defined unit of use.

### SUMMARY OF THE DISCLOSURE

There may be a need to provide sustainable caps for containers, in particular aerosol cans, which can be fastened by means of frictional connection and positive locking and are properly recyclable, reusable or compostable.

These needs may be met by the subject matter of the independent claims. Advantageous embodiments of the present disclosure are described in the dependent claims.

In accordance with a first aspect of the disclosure, a cap for closing a container is described. The cap has a spirally wound (spiral-wound) sleeve comprising a first opening and a second opening. The first opening and the second opening are oppositely arranged. Further, the cap comprises a head disk, wherein the head disk is arranged to close the first opening of the sleeve. The sleeve is made of paper. The second opening of the sleeve comprises a reinforcing element (reinforcing member), wherein the reinforcing element is a structure extending into the interior of the sleeve.

In accordance with another aspect of the disclosure, a method of manufacturing a cap for closing a container is described. The method comprises the steps of: (i) spiral winding a sleeve comprising a first opening and a second opening, wherein the first opening and the second opening are opposed (opposite one another), (ii) arranging a head disk to close the first opening Of the sleeve, wherein the sleeve is made of paper, and (iii) providing a reinforcing element at the second opening of the sleeve, wherein the reinforcing element is a structure extending into the interior of the sleeve.

The sleeve may be a tubular, elongated, cylindrical solid sleeve. In an exemplary embodiment, a tubular, elongated, cylindrical sleeve is characterized in that it has two openings, the two openings being opposite along a longitudinal direction and representing the top surfaces of, for example, a cylinder. In particular, the sleeve may form a rotationally symmetrical body whose axis of symmetry (central axis) is parallel to the longitudinal direction. The sleeve, which corresponds to the lateral surface of a cylinder, may be provided homogeneously, i.e. without further openings or recesses in the lateral surface. Alternatively, there may be at least one further opening or recess in addition to the two openings, which are opposite and may represent the top surfaces of a cylinder. The sleeve may have a diameter of 30 mm (millimeters) to 74 mm, in particular 35 mm to 65 mm.

In the context of the disclosure, the “interior of the sleeve” represents an interior volume which is surrounded by the lateral surface of the sleeve in the direction of extension. The longitudinal direction or the central axis of the sleeve is orthogonal to the radial direction of the sleeve.

In the context of the application, the term “reinforcing element” represent a full or partial circumferential bead which extends from the lateral surface of the sleeve into the interior or inner volume of the sleeve and contributes to the stiffening, mechanical strength and dimensional stability of the sleeve. Furthermore, the reinforcing element serves as a fastening device of the cap on a compatible can, in particular an aerosol can, since the reinforcing element extends into the inner volume and thus forms a releasable connection with, for example, a receiving groove of the can. The reinforcing element may form an integral portion of the sleeve or may consist of a separate element that is materially different from the sleeve. The reinforcing element may also constitute a plurality of bead segments of the bead, which are not fully circumferential and which extend into the interior of the sleeve. In this case, the reinforcing element extends 1% to 10% of the diameter of the sleeve radially inward. In addition, the reinforcing element may extend inwardly not only an extension of 1% to 10% of the diameter of the sleeve in the radial direction, but also with an extension of 5% to 20% of the length of the sleeve in the longitudinal direction.

In the context of the application, the term “paper” represents a flat material, which for example consists of a fibrous material, in particular of vegetable origin (e.g. cellulose, wood pulp and waste paper pulp). Exemplary embodiments of “paper” included paper as well as cardboard and paperboard, which are distinguished on the basis of their mass per unit area (basis weight, grammage) according to DIN 6730, DIN 6730 defines that paper has a basis weight of 7 g/m² to 225 g/m², cardboard has a basis weight of 150 g/m² to 600 g/m², and paperboard has a basis weight of 225 g/m² and above. Further, exemplary embodiments of “paper” may include thin wood plies or cork plies having a thickness similar to paper. Further, the paper may include up to 5% of foreign matter.

The sleeve according to the disclosure is produced in a spiral winding process in which, depending on the intended use and the associated strength requirements, at least one sized paper web is wound onto a fixed mandrel in a partially overlapping manner or butt-wound against one another. Each sized paper web represents one layer of a winding. During the spiral winding process single plies, several single plies on top of each other, or several single plies overlapping into each other can be wound. To provide the layers, the edges of the paper webs may overlap in the longitudinal direction of the sleeve, with the overlapping areas of the paper webs being fastened together, in particular glued.

The head disk may be formed of paper in a single layer or in multiple layers.

The cap for closing a container according to the disclosure exhibits a good CO2 balance as we as environmental compatibility and thus serves to reduce non-recyclable waste. This is made possible by the fact that the cap is made entirely, i.e. both the sleeve and the head disk, of paper. The manufacture of the paper cap by spiral winding of paper webs into sleeves, results in a robust and resistant cap that also keeps cans tight against aerosols or other fluids. Furthermore, making the cap from paper allows caps to be customized in terms of height, diameter and material and thickness, and to be formed with visual designs, e.g., multicolored, or tactile designs, e.g., embossing without much effort or cost. This means that caps can also be produced economically in small batches. Furthermore, by means of the spiral winding technology, the cap can be easily adapted in its height, diameter and material thickness, since no complex adjustments to the production line are necessary, This also makes it possible to manufacture the caps economically in small batches. Furthermore, it is possible to deform the cap by embossing to achieve specific optical or haptic effects. In addition, the cylindrical part may have an optical, haptic or application-specific deformation by special processing; e.g. a grip groove; in order to be able to grip and remove the cap better.

According to another exemplary embodiment of the disclosure, the first opening comprises a bead, in particular a flange, (e.g. with a round cross-section). The bead extends into the interior of the sleeve and the head disk is coupled or attached to the portion of the bead extending into the interior of the sleeve.

The bead may be a full or partial circumferential bead which extends from the (inner) lateral surface of the sleeve into the interior or the inner volume of the sleeve. A flange represents a thickening or bead which, by means of beading or flanging, i.e. bending an edge of the sleeve into the interior, leads to stiffening of the bent edge of the sleeve.

The head disk and the flange are coupled or fastened to each other by providing, for example, a material connection (adhesive connection) and/or a press connection. Exemplary connections may be realized by applying an adhesive to the head disk and/or the flange. Here gluing may realized completely, i.e. along the entire contact surface of the head disk on the flange, or selectively, preferably by means of three adhesive points. Furthermore, a connection between the head disk and the flange may also be realized by means of an interference fit (press fit).

This exemplary embodiment has the advantage that a stable attachment of the head disk to the flange may be provided. Thus, falling out or slipping of a head disk may be reliably prevented, which increases the durability and longevity of the cap. Furthermore, coupling or arranging the head disk on the part of the flange extending into the interior of the sleeve has the advantage that the attachment of the head disk is present within the sleeve, i.e., in the area of the sleeve corresponding to the cylinder volume of the sleeve. As a result, the attachment of the head disk may be protected from environmental influences, which also leads to an increase in the durability and longevity of the caps.

According to another exemplary embodiment of the disclosure, an outer surface of the sleeve and/or an inner surface of the sleeve is provided with a synthetic or bio-based coating.

In the context of the application, the term “outer surface” represents the surface of the sleeve which is in direct contact with an environment of the sleeve and thus exposed to environmental influences. The term “inner surface” represents the surface of the sleeve which is present inside the sleeve. In a further embodiment, the “inner surface” of the head disk, which is present inside the sleeve, and/or the “outer surface” of the head disk, which is in direct contact with the environment, may also be provided with a synthetic or bio-based coating.

Synthetic or bio-based coatings may be applied to the outer or inner surface. These coatings exhibit an impermeability such that the layers of the sleeve, which consist of paper, are insulated, sealed or encapsulated. Exemplary embodiments for synthetic or metal-based coatings are thin-walled plastic layers, e.g. made of PE or PP, or metal layers, e.g. aluminum foils. Coatings may also be colored in this case. exemplary embodiments for bio-based coatings are the following materials: cork, wood, wax or bio-based plastics, e.g. PLA. The exemplary embodiments here are not limited to the above-mentioned materials. The coating has a size/thickness of not more than 20% of the total weight of the cap, preferably less than 5% of the total weight of the cap, to ensure recyclability of the cap.

This exemplary embodiment has the advantage that the resistance of the sleeve to, for example, grease, oil and water may be improved. Thus, the longevity or the cap may be increased.

According to another exemplary embodiment of the disclosure, the sleeve comprises at least an inner layer and an outer layer. Both layers are spirally wound.

The outer layer is the radially outermost paper layer and comprises the outer surface. The inner layer is the paper layer that comprises the inner surface. A large number of other layers may be arranged between the inner layer and the outer layer.

By means of the appropriate number of layers, any thickness of the sleeve may be set. This may increase the strength and dimensional stability of the sleeve.

According to another exemplary embodiment of the disclosure, the reinforcing element comprises a thickened area (thickened portion, thickened region) or bead at the second opening of the sleeve. The thickened are may be provided by means of flanging an end portion of the sleeve into the interior of the sleeve, wherein the flanged end portion of the sleeve is compressed in the radial direction.

The end region of the sleeve at the second opening is that which is directly present at the second opening of the sleeve and which comprises an end edge of the sleeve. After flanging, or after folding the end region of the sleeve inwards, a cavity may be present between the layers which are in contact after folding, or the layers may be in loose contact. To achieve a better reinforcement effect, a pressing force may be applied in the radial direction to press the adjacent plies together and compact them.

This exemplary embodiment has the advantage of creating a thickened area which, on the one hand, increases the dimensional stability of the sleeve or cap and, on the other hand, reduces the diameter of the cap at the second opening of the sleeve towards the inside. By reducing the inner diameter at the second opening of the sleeve, a tight, non-slip fit of the cap on a compatible can, in particular aerosol cans, may be ensured. The can may have a corresponding receiving groove for the thickened area or bead for better attachment. The inner diameter at the bead may be configured and adjusted such that a filled can may be lifted only at the cap without the cap detaching from the compatible can.

The end area or end edge of the sleeve describes the axial end of the sleeve. A cut edge of the sleeve describes the open section of the plies, if the plies end axially with an open cut edge in the end section, there is a risk that moisture will penetrate between the paper plies and loosen the bond between the paper plies or cause swelling. By flanging or folding the end area of the sleeve into the interior of the sleeve, the outer layer surrounds the axial end of the sleeve so that less moisture can penetrate between the layers of the sleeve. The cut edge is present inside the sleeve. Thus, the durability and longevity of the cap may be increased.

According to another exemplary embodiment of the disclosure, the reinforcing element comprises a thickened area at the second opening of the sleeve. The thickened area is provided by means of applying an adhesive, in particular a recyclable adhesive.

The recyclable adhesive represents an adhesive that is recyclable and/or has only a minor impact on the environment. Exemplary embodiments for a recyclable adhesive include the following substances: Natural rubber, formaldehyde-free dispersion adhesives (PVAC sugar, adhesive) and lignin-based polymer adhesives (LignoGlue).

This exemplary embodiment has the advantage that a thickened area is also created, which on the one hand increases the dimensional stability of the sleeve or cap and on the other hand reduces the diameter of the cap at the second opening of the sleeve towards the inside. This may ensure a tight, non-slip fit of the cap on a compatible can, in particular aerosol cans. Further, the application of an adhesive seals an open cut edge of the sleeve at the second opening so that protection from environmental influences, such as atmospheric moisture, may be provided. Thus, the durability and longevity of the cap may be increased.

According to another exemplary embodiment of the disclosure, the reinforcing element comprises a thickened area at the second opening of the sleeve. The thickened area is provided by folding down the outer layer into the Interior of the sleeve so that the outer layer at least partially covers the at least one inner layer (at its axial end).

This exemplary embodiment has the advantage that s thickened area is also created, which on the one hand increases the dimensional stability of the sleeve or cap and on the other hand reduces the diameter of the sleeve at the second opening of the sleeve. This may ensure a tight, non-slip fit of the cap on a compatible can, in particular aerosol cans. Furthermore, by folding down the outer layer into the interior of the sleeve, with the outer layer at least partially covering an inner layer, a lower cut edge of the inner layer is protected when the sleeve is opened, so that protection against environmental influences, for example an entry of atmospheric moisture, may be provided. Thus, the durability and longevity of the cap may be increased.

According to another exemplary embodiment of the disclosure, arranging a head disk comprises the following process steps: (I) flanging, in particular flanging with a round cross-section, the first opening of the sleeve, (II) feeding the head disk, and (III) coupling the head disk to the flange extending into the interior of the sleeve, in particular to the part of the flange arranged inside the sleeve.

According to another exemplary embodiment of the disclosure, providing a reinforcing element at the second opening of the sleeve comprises a thickened area. The thickened area is provided by means of one of: (a) flanging, in particular flanging with a circular cross-section, the second opening and then compressing the resulting flange in a radial direction; (b) arranging an adhesive, in particular a recyclable adhesive, at the second opening; and (c) when the sleeve comprises at least an inner layer and an outer layer, folding down the outer layer of the sleeve so that the outer layer at least partially covers the at least one inner layer.

It is pointed out that embodiments described herein represent only a limited selection of possible embodiments of the disclosure. For instance, it is possible to combine the features of individual embodiments in a suitable manner, so that a multitude of different embodiments are to be regarded as obviously disclosed to the person skilled in the art with the embodiments made explicit herein.

### BRIEF DESCRIPTION OF THE DRAWING

FIG. 1 shows a cross-section of an embodiment according to the disclosure of the cap.

FIG. 2 shows a side view of an embodiment according to the disclosure of the cap according to FIG. 1,

FIG. 3 shows a cross-section of a detailed view of an embodiment according to the disclosure of the reinforcing element of the cap according to FIG. 1.

FIG. 4 shows a cross-section of a detailed view of a further embodiment according to the disclosure of the reinforcing element of the cap according to FIG. 1.

FIG. 5 shows a cross-section of a detailed view of a further embodiment according to the disclosure of the reinforcing element of the cap according to FIG. 1.

### DETAILED DESCRIPTION

It is pointed out that in the following detailed description, features or components of different embodiments which are identical or at least functionally identical to the corresponding features or components of another embodiment are provided with the same reference signs or with reference signs which are identical in the last two digits to the reference signs of corresponding identical or at least functionally identical features or components. To avoid unnecessary repetitions, features or components already explained on the basis of a previously described embodiment will not be explained in detail at a later point.

It is further pointed out that the representation in the figures is schematic and not to scale.

It is further pointed out that space-related terms, such as “front” and “back,” “top” and “bottom,” “left” and “right,” etc., are used to describe the relationship of an element to another element or to other elements, as illustrated in the figures. Accordingly, the space-related terms may apply to orientations which are different from the orientations illustrated In the figures. It is understood, however, that all such space-related terms refer to the orientations shown in the drawings for the sake of simplicity of description and are not necessarily limiting, since the particular device, component, etc. shown, when in use, may assume orientations that may be different from the orientations shown in the drawing.

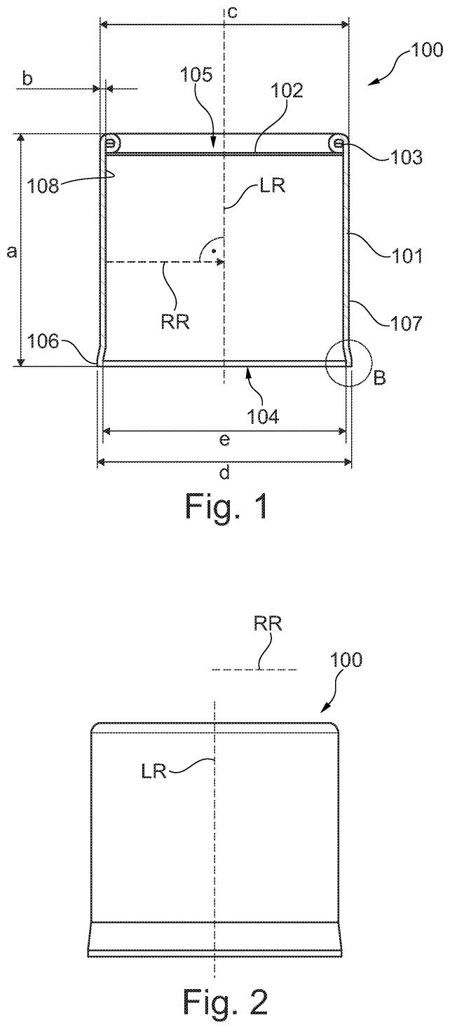

FIG. 1 shows a cap 100 for closing a container, in particular an aerosol can. The cap 100 comprises a spirally wound sleeve 101 that comprises a first opening 105 and a second opening 104. The first opening 105 and the second opening 104 are opposed. Further, the cap 100 comprises a head disk 102, wherein the head disk 102 is arranged to close the first opening 105 of the sleeve 101. The sleeve 101 and the head disk 102 are made of paper. The second opening 104 of the sleeve 101 comprises a reinforcing element 106, wherein the reinforcing element 106 is a structure extending into the interior of the sleeve 101.

The cap 100 comprises an elongated cylindrical tubular sleeve 101. The sleeve 101 has a length a, a thickness or material thickness b, and a width c. The width c is defined as the distance between the outer surface 107 of the sleeve 101 at that of a first opening 105 of the sleeve 101 in the radial direction RR. In particular, the sleeve 100 is a rotationally symmetrical body having an axis of symmetry (central axis) parallel to the longitudinal direction (length direction) LR. The radial direction RR is perpendicular to the center axis and intersects it. The length a is defined as the distance between the first opening 105 and a second opening 104. The thickness or material thickness b is defined as the distance between a radially inner surface 108 and the radially outer surface 107. Here, the thickness or material thicknesses b of the sleeve 101 is determined by the number of paper plies as well as the thickness of the paper piles. The sleeve 101 and the head disk 102 may comprise the same or a different number of paper plies. In this embodiment shown in FIG. 1, the cap 100, i.e. the sleeve 101 and the head disk 102, comprises 3 plies, i.e. spirally wound paper webs.

Further, the sleeve 101 comprises the first opening 105 and the second opening 104. A flange 103 is directly arranged at the first opening 105. A flange is generally used to stiffen a bent edge of a structure and is formed by bending an edge of a structure. This flange 103 is circumferential and has a circular shape in cross-section, which extends both inwardly in the radial direction RR and outwardly in the longitudinal direction LR. In other words, the flange 103 extends into an area corresponding to the cylindrical volume of the sleeve. The second opening 104 is opposite the first opening 105, wherein the first opening 105 and second opening 104 respectively represent the top surfaces of a cylinder and of the sleeve 101, respectively. After flanging, or after folding the end region of the sleeve inwards, as in FIG. 1, a cavity may be present between the layers that are in contact after folding, or the layers may be in loose contact.

The sleeve 101 is homogeneous, i.e., no further openings or recesses are present in the lateral surface of the sleeve 101 besides the first opening 105 and the second openings 104. In a further exemplary embodiment, at least one further opening may be provided in the sleeve, for example in the lateral surface or the head disk. This has the advantage that a head portion of a can, which may remain in the shower for example, may dry and corrosion by water of the valve carrier covered by the cap is prevented, since water may exit through the further opening. This also prevents water from attacking the cap through long-term exposure.

A head disk 102 is coupled to the flange 103. The head disk 102 may be completely or selectively bonded to the flange 103 by means of an adhesive, in particular a recyclable adhesive. Furthermore, the head disk 102 may also be attached to the flange 103 by means of an interference fit.

The head disk 102 may be made from a multi-layered cardboard. The sleeve 101 may be made of spirally wound paper, cardboard, paperboard, thin layers of wood, or other thin walled materials that can be processed as described.

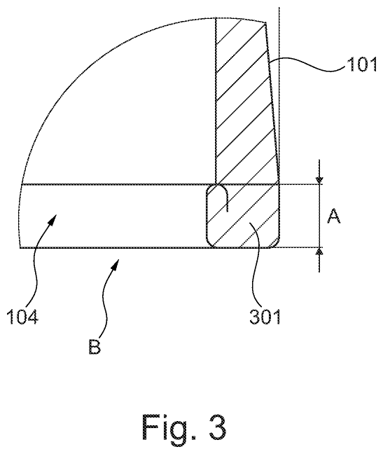

A reinforcing element 106 is directly arranged at the second opening 104, which leads to a stiffening, an increased strength and dimensional stability of the sleeve 101. Further embodiments of a reinforcing element 106 are shown in detail B in FIGS. 3 to 5. The reinforcing element 106 is a structure, in particular a circumferential bead, which extends into the interior of the sleeve 101. Here, the reinforcing element 106 extends inwardly both in the radial direction RR, preferably with 1% to 10% of the width c of the sleeve 101, and inwardly in the longitudinal direction LR, preferably with 5% to 20% of the length a of the sleeve 101, and is thus present in the region corresponding to the cylinder volume of the sleeve 101. In the embodiment shown in FIG. 1, in the region in which the reinforcing element 106 is present on the inner surface 108 of the sleeve 101, the diameter of the cap 100 is larger, which also ensures a tight, non-slip fit on a compatible can, in particular an aerosol can. Within this range, a width d of the sleeve 101 at the second opening 104 is greater than a width e of the second opening 104, with the width c of the sleeve 101 at the first opening 105 being between the width d and the width e. In this regard, a widening of the cap extends 0.5% to 2% of the width c of the sleeve 101 at the first opening 105.

FIG. 2 shows a side view of an embodiment according to the disclosure of the cap 100 as shown in FIG. 1. The cap 100 has a longitudinal direction LR and a radial direction RR, wherein the radial direction RR is orthogonal to the longitudinal direction LR. The longitudinal direction LR in FIG. 2 runs along the center axis.

FIG. 3 shows a cross-section of a detailed view B of an embodiment according to the disclosure of the reinforcing element 106. The reinforcing element 301 has a thickened area A. The thickened area A extends into the interior of the sleeve 101. The thickened area A extends into the interior of the sleeve 101. The thickened area A is provided into the interior of the sleeve 101 by means of flanging or folding down an end portion, i.e., a portion which is directly arranged at an opening of the sleeve 101 and has a cut edge of the sleeve 101. In addition to flanging the end portion into the interior of the sleeve 101, the flanged end portion is compressed in the radial direction RR. Compression of the flanged end portion is achieved here by means of applying a compressive force outward in the radial direction RR. Furthermore, compression may be provided by means of a combination of thermal compression and mechanical compression with a counter-guide, a so-called “thermo-mechanical compression”.

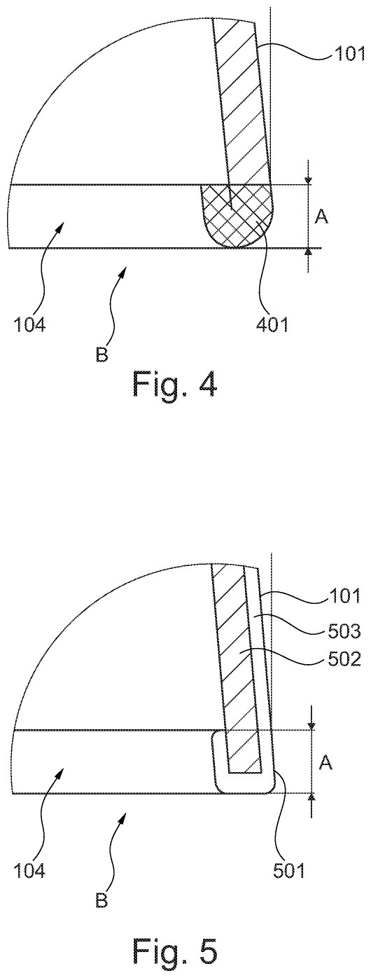

FIG. 4 shows a cross-section of a detailed view B of a further embodiment according to the disclosure of the reinforcing element 106 of the cap 100. The reinforcing element 401 has a thickened area A. The thickened area A extends into the interior of the sleeve 101, which may be achieved by means of targeted adhesive application using adhesive nozzles. Further, the thickened area A may extend into the interior of the sleeve as well as outwardly. The thickened area A is provided by means of applying an adhesive, in particular a recyclable adhesive, which extends into the interior of the sleeve 101. A recyclable adhesive is here an adhesive which is properly recyclable.

FIG. 5 shows a cross-section of a detailed view B of a further embodiment according to the disclosure of the reinforcing element 106 of the cap 100. The reinforcing element 501 has an area A at the second opening 104 of the sleeve 101. The area A is provided by means of folding down an outer layer 503 into the interior of the sleeve 101 around a free end of the inner layer 502. In this case, the outer layer 503 covers an Inner layer 502 at least partially on the inner side, i.e., the outer layer 503 completely covers the end portion of the inner layer 502 of the sleeve 101. In this embodiment, the cap may be held by the friction-induced frictional connection between the cap and the aerosol can.

It is noted that the terms “comprise” or “have” do not exclude other elements and that the “a” does not exclude a plurality. Also, elements described in connection with different embodiments may be combined. It should also be noted that reference signs in the claims should not be construed as limiting the scope of the claims.

### REFERENCE SIGNS

100 cap

101 sleeve

102 head disk

103 flange

104 second opening

105 first opening

106 reinforcing element

107 outer surface

108 inner surface

301 reinforcing element

401 reinforcing element

501 reinforcing element

502 inner position

503 outer position

a length of the sleeve

b thickness/material thickness of the sleeve

c width of the sleeve at the first opening

d width of the sleeve at the second opening

e width of the second opening

A thickened area

B detail

LR longitudinal direction

RR radial direction

1.-10. (canceled)

11. A cap for closing a container, the cap comprising:
a spirally wound sleeve comprising a first opening and a second opening, wherein the first opening and the second opening are opposed;
a head disk,
wherein the head disk is arranged to close the first opening of the sleeve,
wherein the sleeve is made of paper,
wherein the second opening of the sleeve comprises a reinforcing element, and
wherein the reinforcing element is a structure extending into the interior of the sleeve.

12. The cap according to claim 11,
wherein the first opening comprises a bead,
wherein the bead extends into the interior of the sleeve, and
wherein the head disk is coupled to the portion of the bead extending into the interior of the sleeve.

13. The cap according to claim 11,
wherein at least one of an outer surface of the sleeve and an inner surface of the sleeve is provided with a synthetic or bio-based coating.

14. The cap according to claim 11,
wherein the sleeve comprises at least an inner layer and an outer layer which are spirally wound.

15. The cap according to claim 11,
wherein the reinforcing element comprises a thickened area at the second opening of the sleeve, wherein the thickened area is provided by flanging an end portion of the sleeve into the interior of the sleeve,
wherein the flanged end portion of the sleeve is compressed in a radial direction.

16. The cap according to claim 11,
wherein the reinforcing element comprises a thickened area at the second opening of the sleeve, wherein the thickened area is provided by means of applying an adhesive.

17. The cap according to claim 14,
wherein the reinforcing element comprises a thickened area at the second opening of the sleeve,
wherein the thickened area is provided by folding down the outer layer into the interior of the sleeve so that the outer layer at least partially covers the at least one inner layer.

18. A method of manufacturing a cap for closing a container, the method comprising:
spiral winding a sleeve comprising a first opening and a second opening,
wherein the first opening and the second opening are opposed,
arranging a head disk to close the first opening of the sleeve,
wherein the sleeve is made of paper,
providing a reinforcing element at the second opening of the sleeve,
wherein the reinforcing element is a structure extending into the interior of the sleeve.

19. The method according to claim 18,
wherein arranging a head disk comprises:
flanging of the first opening of the sleeve, feeding the head disk, and
coupling the head disk to the flange which extends into the interior of the sleeve.

20. The method according to claim 18,
wherein providing a reinforcing element at the second opening of the sleeve comprises a thickened area,
wherein the thickened area is provided by means of one of:
flanging of the second opening and subsequently compressing the resulting flange in a radial direction;
arranging an adhesive at the second opening;
when the sleeve comprises at least an inner layer and an outer layer, folding down the outer layer of the sleeve so that the outer layer at least partially covers the at least one inner layer.

21. The cap according to claim 12,
wherein the bead is a flange.

22. The cap according to claim 16,
wherein the adhesive is a recyclable adhesive.

23. The method according to claim 19,
wherein flanging of the first opening of the sleeve comprises flanging with a round cross-section.

24. The method according to claim 19,
wherein coupling the head disk to the flange comprises coupling the head disk to that part of the flange which is arranged inside the sleeve.

25. The method according to claim 20,
wherein flanging of the second opening comprises flanging with a round cross-section.

26. The method according to claim 20,
wherein the adhesive is a recyclable adhesive.
